(19) United States
(12) Patent Application Publication
(10) Pub. No.: US 2022/0366439 A1
(43) Pub. Date: Nov. 17, 2022

(54) OBJECT SEGMENTATION BASED ON MULTIPLE SETS OF METRICS

(71) Applicant: Intuit Inc., Mountain View, CA (US)

(72) Inventors: Xue Han, Sunnyvale, CA (US); Zhicheng Xue, Union City, CA (US)

(73) Assignee: Intuit Inc., Mountain View, CA (US)

(21) Appl. No.: 17/244,388

(22) Filed: Apr. 29, 2021

(51) Int. Cl. G06Q 30/02; G06F 16/23; G06Q 40/02; G06N 20/00

(52) U.S. Cl. CPC G06Q 30/0204; G06F 16/2379; G06Q 40/025; G06Q 30/0201; G06N 20/00; G06Q 40/08

(57) ABSTRACT

Systems and methods for segmenting a group of objects concurrently based on two or more sets of metrics are disclosed. A system is configured to obtain a set of first metrics for the group of objects, with the set of first metrics including, for each object, a first metric associated with the object. The system is also configured to obtain a set of second metrics for the group of objects, with the set of second metrics including, for each object, a second metric associated with the object. The system is also configured to segment the group of objects into one or more segments concurrently based on the set of first metrics and the set of second metrics and to generate a data set including the one or more segments. For example, entities may be segmented concurrently based on a first credit score and a second credit score of each entity.

### TECHNICAL FIELD

This disclosure relates generally to segmentation of objects based on multiple sets of metrics.

### DESCRIPTION OF RELATED ART

Segmentation is used in many fields to group objects based on similar metrics. For example, to classify insects into similar groups, insects may be segmented into different species based on body type or length, limb type or length, etc. For home buyers, homes may be segmented into different groups based on neighborhood, school district, home price, home amenities, home size, etc. For insurance, entities (such as persons, business, or assets) may be segmented into different groups based on a risk score. For credit worthiness, entities (such as persons, businesses, or assets) may be segmented into different groups based on a credit score.

Members of a same group may be observed and compared to determine traits common to the group. For example, a specific species of insect may be observed/compared to determine life span, diet, etc. Homes in a common group may be compared to determine an age range of the homes, quality of the school district, etc. Entities in a common group of insurance risk may be compared to determine common accident frequencies and behaviors, insurance claim habits, etc. Entities in a common group of credit scores may be compared to determine common revenue, spending, saving, or debt traits. Decisions for an object may be based on the assigned group. For example, insurance policy approval for an entity may be based on a risk group to which the entity is assigned.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for segmenting a plurality of objects into one or more groups based on two or more sets of metrics. The example method includes obtaining a set of first metrics for the group of objects, with the set of first metrics including, for each object in the group of objects, a first metric associated with the object. The method also includes obtaining a set of second metrics for the group of objects, with the set of second metrics including, for each object in the group of objects, a second metric associated with the object. The method also includes segmenting the group of objects into one or more segments concurrently based on the set of first metrics and the set of second metrics. The method also includes generating a data set including the one or more segments, with the data set being stored by the system.

Another innovative aspect of the subject matter described in this disclosure can be implemented in a system for segmenting a plurality of objects into one or more groups based on two or more sets of metrics. An example system includes one or more processors and a memory storing instructions that, when executed by the one or more processors, cause the system to perform operations. The operations include obtaining a set of first metrics for the group of objects, with the set of first metrics including, for each object in the group of objects, a first metric associated with the object. The operations also include obtaining a set of second metrics for the group of objects, with the set of second metrics including, for each object in the group of objects, a second metric associated with the object. The operations also include segmenting the group of objects into one or more segments concurrently based on the set of first metrics and the set of second metrics. The operations also include generating a data set including the one or more segments, with the data set being stored by the system.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 shows an example system for training a machine learning model.

FIG. 2 shows an illustrative flow chart depicting an example operation for segmenting a plurality of objects, according to some implementations.

FIG. 3 shows an example binning matrix for segmentation, according to some implementations.

FIG. 4 shows an example rectangular shaped segmented binning matrix based on the binning matrix in FIG. 3, according to some implementations.

FIG. 5 shows an example segmented binning matrix based on the rectangle shaped segmented binning matrix in FIG. 4, according to some implementations.

Like numbers reference like elements throughout the drawings and specification.

### DETAILED DESCRIPTION

Implementations of the subject matter described in this disclosure may be used to segment a plurality of objects into one or more groups based on two or more sets of metrics. For example, a group of entities (such as persons, businesses, or assets (such as bonds, stock, etc.)) may be segmented to indicate their credit-worthiness. The segmentation may be performed concurrently based on two or more risk metrics for the group of entities (such as two or more different credit scores per entity). Implementations of the subject matter described in this disclosure may also be used to automatically generate decisions based on the segmentation. For example, a system may automatically approve an entity (such as a person or business) for a loan or automatically determine one or more terms of the loan based on the segmentation.

Segmentation of a plurality of objects into segments of objects based on one set of metrics is performed in many areas. For example, weather forecasting systems segment tornadoes or hurricanes into categories based on wind speed. In another example, credit monitoring systems group persons into tiers based on a Fair, Isaac and Company (FICO) score. Segmenting may include determining natural divisions between groups of objects to maximize a divergence in a characteristic of the objects from one group to the next. To segment based on one set of metrics, the metric may be divided into a plurality of ranges, and the plurality of objects may be divided into groups based on the ranges (such as binning the objects into bins based on the ranges). The bins may be analyzed with reference to one another to determine natural divisions between objects based on a characteristic of the objects.

Some entities may desire to segment objects based on multiple metrics. For example, an insurance company may obtain a publicly available first risk metric from another company (such as a credit agency) and may obtain a proprietary second risk metric generated within the insurance company. The insurance company may desire to segment entities based on the first risk metric and the second risk metric, and the segments may be used to determine an insurance rate or risks associated with insuring an entity in the segment (such as insuring a person, a car, a home, personal effects, a company, etc.). In another example, a credit card firm or another credit firm may obtain a publicly available credit score (such as a FICO score) and may generate a proprietary credit score. The credit firm may desire to segment entities based on the first credit score and the second credit score, and the segments may be used to determine approval for a loan or line of credit, an interest rate, a length of the loan, guarantees required for obtaining credit, or other terms of providing credit to an entity. As used herein, an entity may be a person, a household, a company, a partnership, an equity (such as a stock or bond), other assets, etc. A group of objects may be any suitable group of items that may be categorized based on one or more metrics (such as tornadoes or hurricanes categorized based on wind speed, annuities or pensions categorized based on funding level, home values categorized based on home amenities, diamonds categorized based on clarity and cut, entities categorized based on credit scores, etc.).

Conventional methods of segmenting a group of objects based on two metrics requires a sequential segmentation of the objects based on the metrics. In other words, the group of objects is segmented based on the first metric. Then, the segmented group of objects is further segmented/processed based on the second metric. For example, tree-based segmentation may be used to segment a group of objects based on multiple metrics, with sequential rules used to segment the group of objects using the metrics in a sequential manner. As a result, segmentation is based on a hierarchy of the metrics, with the first metric having a higher priority than the second metric.

Segmentation that is sequentially based on the metrics causes the first metric to unduly influence the segmentation as compared to the second metric. In particular, such sequential forms of segmentation does not always lead to an optimum segmentation (such a causing a maximum divergence in a characteristic of the objects among segments). Sequential forms of segmentation may also not result in an optimum number of segments. In a practical example, a group of entities may be segmented based on loan default risk. If sequential segmentation is performed based on two different credit scores, segmentation prioritizes a first credit score over a second credit score based on the hierarchy in credit scores inherent in the segmentation. In this manner, the segmentation may not be optimized such that some entities may exist in a higher risk segment than necessary, or the number of segments may not be sufficient to capture entities forced into one of two separate risk segments of which there is little relation. In the specific example, an entity may be denied credit, provided a higher interest, or given more onerous terms in obtaining credit as a result of being placed into a non-optimum credit segment based on the entity's credit scores. In general, sub-optimal segmentation may cause non-optimal decision making or more manual oversight over decision making (such as regarding the approval of credit, with a credit firm requiring applications from all entities towards the edges of such risk segments to be manually reviewed by one or more experts (which may also be susceptible to human error)).

Various implementations of the subject matter disclosed herein provide one or more technical solutions to the technical problem of segmenting a group of objects concurrently based on multiple metrics. A computing system may be configured to segment a group of objects concurrently based on at least a first metric and a second metric. For example, a computing system may be used by an insurance agency or a credit firm to segment a group of entities (such as companies, persons, households, or assets) concurrently based on at least a first risk metric and a second risk metric (with the segmentation used to approve a loan, approve an insurance policy, determine an interest rate, determine a policy rate, etc.). In a specific example, a computing system may be used by a credit firm to segment a group of entities concurrently based at least on a first credit score and a second credit score. The computing system may use the segmentation to automatically approve a loan, determine a loan interest rate, or determine other terms of the loan.

Unlike conventional systems for segmenting a group of objects sequentially based on a first metric then a second metric, segmenting the group of objects concurrently based on the first metric and the second metric allows segmentation to be optimized for a maximum divergence in a characteristic of the objects among segments and an optimum number of segments based on both metrics. For example, an optimum segmentation may maximum a divergence in default rates of loans among the different segments. In this manner, computer generated decisions (such as loan approvals, draft insurance policy generation, etc.) may be improved based on the improved or optimum segmentation.

Various aspects of the present disclosure provide a unique computing solution to a unique computing problem that did not previously exist. More specifically, the problem of optimizing computer implemented segmentation and computer generated decisions did not exist prior to the use of computer implemented models for segmentation and decision making based on vast numbers of objects and related metrics, and is therefore a problem rooted in and created by technological advances to accurately segment groups of objects to maximize differentiation between different segments of objects for decision making.

As the number of objects and metrics increase, the ability to segment the objects (and thus be able to make a determination based on the segmentation) requires the computational power of modern processors and machine learning models to accurately make such decisions (which may be in real-time). For example, hundreds of thousands or millions of entities may be segmented concurrently based on two or more metrics. Therefore, implementations of the subject matter disclosed herein are not an abstract idea such as organizing human activity or a mental process that can be performed in the human mind, for example, because it is not practical, if even possible, for a human mind to evaluate multiple metrics of hundreds of thousands to millions, or more, of entities at the same time to segment the entities concurrently based on multiple metrics for decision making. As such, implementations of the subject matter disclosed herein are not an abstract idea such as organizing human activity or a mental process that can be performed in the human mind, much less using pen and paper.

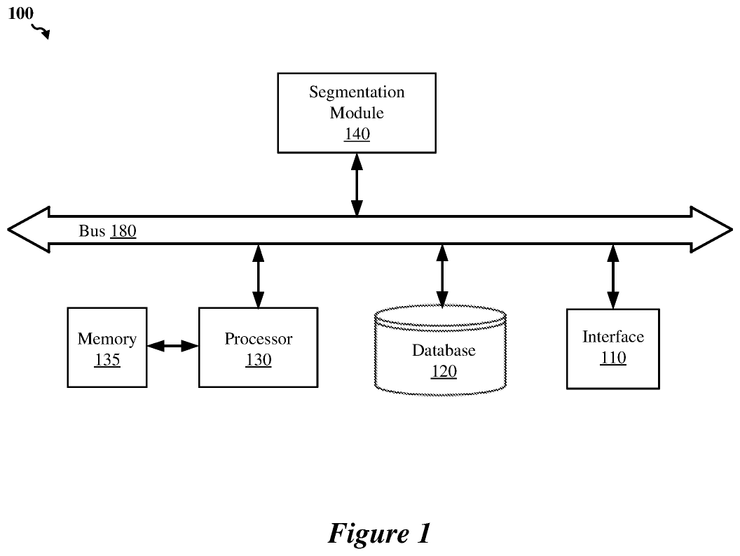

FIG. 1 shows an example system 100 for segmenting a group of objects, according to some implementations. The system 100 includes an interface 110, a database 120, a processor 130, a memory 135 coupled to the processor 130, and a segmentation module 140. In some implementations, the various components of the system 100 may be interconnected by at least a data bus 180, as depicted in the example of FIG. 1. In other implementations, the various components of the system 100 may be interconnected using other suitable signal routing resources.

The interface 110 may be one or more input/output (I/O) interfaces to receive information regarding a group of objects, such as one or more of a first metric or a second metric, identifying information for the objects, etc. The interface 110 may also be configured to output a result of the segmentation of the group of objects, such as a data set in a computer readable format to be provided to another system for ingestion and use by an application executed on the system. The interface 110 may also be configured to output an automatically generated decision regarding a loan, an automatically generated policy or contract, etc. to be provided to an entity, or other suitable results. An example interface may include a wired interface or wireless interface to the internet or other means to communicably couple with user devices or other systems. For example, the interface 110 may include an interface with an ethernet cable or a wireless interface to a modem, which is used to communicate with an internet service provider (ISP) directing traffic to and from devices of a user or other institutions to obtain input data (such as credit scores for a group of entities from a credit bureau) or provide output data (such as providing a loan approval decision to a user). In another example, the interface 110 may include an interface to a local storage device or a remote storage device from which to obtain the input data or to which to store the output data. The interface 110 may also include a display, a speaker, a mouse, a keyboard, or other suitable input or output elements that allow interfacing with the system 100 by a local user or moderator. For example, the system 100 may be a personal computer, and the interface 110 may include a display, a keyboard, and/or a mouse.

The system 100 may be configured to execute an application for which the segmentation is used. For example, the system 100 may execute a loan submission application. In this manner, the system 100 may automatically determine whether a loan is approved, an interest rate of the loan, a security deposit for the loan, or other terms of the loan based on the segmentation of entities concurrently based on two or more risk metrics (such as credit scores). In another example, the system 100 may execute an insurance request application. In this manner, the system 100 may automatically determine approval for an insurance policy, a policy premium, a policy deductible, or other terms of the policy for an entity based on the segmentation of entities concurrently based on two or more risk metrics (such as a policy redemption metric and a solvency metric of companies to pay the premium and deductible).

The database 120 may store the input data (such as identification information, a first metric, a second metric, etc. for the group of objects). The database 120 may also store one or more applications to be executed by the system 100, one or more data sets generated by the segmentation, or one or more parameters for segmenting the group of objects. In some implementations, the database 120 may include a relational database capable of presenting information as data sets in tabular form and capable of manipulating the data sets using relational operators. The database 120 may use Structured Query Language (SQL) for querying and maintaining the database 120.

The processor 130 may include one or more suitable processors capable of executing scripts or instructions of one or more software programs stored in system 100 (such as within the memory 135). For example, the processor 130 may be capable of executing one or more applications or software from the segmentation module 140. The processor 130 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processors 130 may include a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the processor 130 to perform one or more corresponding operations or functions. For example, the memory 135 may store the one or more applications or software from the segmentation module 140 that may be executed by the processor 130. The memory 135 may also store the input data and/or the output data. For example, the memory 135 may store a data set generated from segmenting a group of objects. The data set may indicate the segments and the ranges of the different metrics associated with each segment. In some implementations, the data set may indicate which objects from the group of objects are included in each segment. In some implementations, hardwired circuitry may be used in place of, or in combination with, software instructions to implement aspects of the disclosure. As such, implementations of the subject matter disclosed herein are not limited to any specific combination of hardware circuitry and/or software.

The segmentation module 140 may be configured to segment a group of objects. For example, the segmentation module 140 may obtain a group of objects (such as an identification number for each object), a first metric for each object, and a second metric for each object (such as via the interface 110, the database 120, and/or the memory 135). The segmentation module 140 may also be configured to segment the group of objects concurrently based on the first metric and the second metric. As noted, segmentation of a group of objects may be concurrently based on two or more metrics. For clarity in describing aspects of the disclosure, specific examples use a group of entities (such as a group of businesses or a group of persons) as the group of objects. The specific examples also use a first risk metric (such as a first credit score) and a second risk metric (such as a second credit score) as the two or more metrics. Aspects of the disclosure, though, may be used for segmenting any suitable group of objects concurrently based on any suitable metrics and any suitable number of metrics. For example, segmentation concurrently based on two metrics is used in the examples so that an example binning matrix may be conceptualized as a two-dimensional matrix and sot that functions or equations related to segmentation of the two-dimensional matrix may be explained with clarity. However, any suitable number of metrics may be used, with a resulting binning matrix being a matrix having three or more dimensions and the functions or equations described below for a two-dimensional matrix being expanded to the higher dimensional binning matrix.

While the segmentation module 140 is depicted as a separate, single component from the processor 130, the memory 135, and the database 120 of the system 100 in FIG. 1, the segmentation module 140 may be included in one or more other components of system 100 (such as dedicated hardware included in processor 130 and/or software stored in memory 135) or may include additional components. For example, the segmentation module 140 may include software including instructions stored in memory 135 or the database 120, may include application specific hardware (e.g., one or more ASICs), or a combination of the above. In some implementations, the segmentation module 140 includes executable instructions in the Python programming language from the pywraplp application programming interface (API) from the OR-Tools Suite to generate a mixed integer programming (MIP) model to be solved. The segmentation module 140 may also include a Coin-or branch and cut (CBC) solver to solve the generated MIP model. An interface may be used to ingest the MIP model in the Python language format into a format readable by the CBC solver. The CBC solver may generate the data set indicating the segments and the ranges of metrics associated with each segment, with the data set stored by the system 100 for use by the system 100 or another device in decision making (such as in automatic loan approval for a loan application). The data-set is in computer readable form for ingestion by such decision making application and/or in tabular form for manipulation or manual inspection.

As such, the particular architecture of the system 100 shown in FIG. 1 is but one example of a variety of different architectures within which aspects of the present disclosure may be implemented. For example, in other implementations, components of the system 100 may be distributed across multiple devices, may be included in fewer components, and so on. While the below examples are described with reference to system 100, any suitable system may be used to perform the operations described herein.

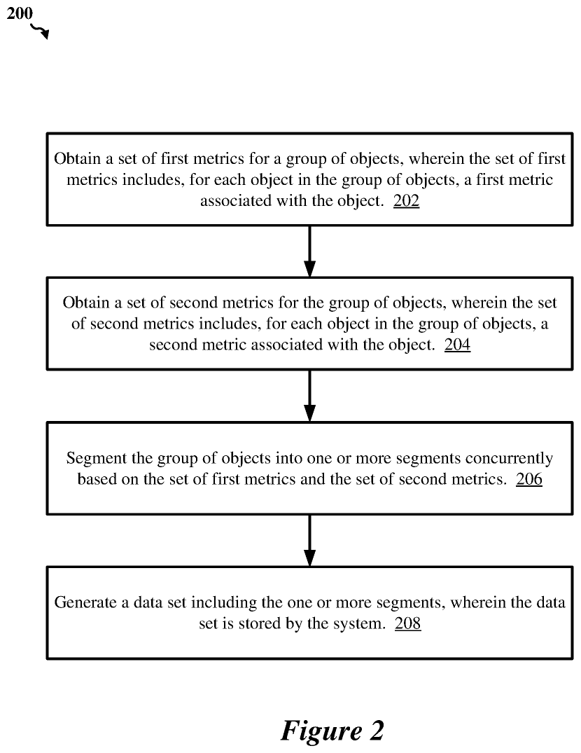

FIG. 2 shows an illustrative flow chart depicting an example operation 200 for segmenting a group of objects. At 202, the system 100 obtains a set of first metrics for a group of objects. The set of first metrics includes, for each object in the group of objects, a first metric associated with the object. At 204, the system 100 obtains a set of second metrics for the group of objects. The set of second metrics includes, for each object in the group of objects, a second metric associated with the object. As used herein, “obtaining” a set of metrics may refer to the system 100 determining at least a portion of the metrics, receiving at least a portion of the metrics, or a combination of both. For example, obtaining a set of first metrics and a set of second metrics may refer to the system 100 determining the set of first metrics (e.g., executing one or more machine learning models to generate a first credit score for each entity) and receiving the set of second metrics from another device (e.g., receiving a publicly available credit score from a credit bureau).

At 206, the system 100 segments the group of objects into one or more segments concurrently based on the set of first metrics and the set of second metrics. For example, the system 100 (such as the segmentation module 140) may be configured to segment a group of entities concurrently based on a first risk metric and a second risk metric. In one example, the system 100 may be used by an insurance company to segment a group of entities into risk tiers concurrently based on a first risk metric and a second risk metric. In this manner, the system 100 obtains the set of first risk metrics and the set of second risk metrics for the group of entities, and the system 100 segments the group of entities into risk tiers concurrently based on the first risk metrics and the second risk metrics. In another example, the system 100 may be used by a credit firm (such as a credit card company, a bank, or investment firm that may provide loans or credit) to segment a group of entities into credit worthiness tiers concurrently based on a first credit score and a second credit score. In this manner, the system 100 obtains the set of first credit scores and the set of second credit scores for the group of entities, and the system 100 segments the group of entities into credit worthiness tiers concurrently based on the first credit score and the second credit score.

At 208, the system 100 generates a data set including the one or more segments, wherein the data set is stored by the system 100. As noted above, the data set may indicate the ranges of metrics associated with each segment. The data set may also include other information, such as an indication of a credit risk or other common characteristic of each segment. The data set may be embodied in a specific programming language (such as Python) and stored in the memory 135 and/or the database 120. The data set may be provided to the processor 130 executing a decision making application (such as a loan submission application or insurance policy application) for ingestion and use in generating a risk determination, a loan approval, a loan or insurance policy terms and conditions, or other decisions for an entity. The data set may alternatively or additionally be provided (such as via the interface 110) to another system configured for decision making. In some implementations, the data set may be in a SQL format for storage in the database 120 or another suitable computer readable format.

While not shown in FIG. 2, in some implementations, the system 100 is configured to generate a risk determination of an entity based on the data set and output the risk determination of the entity. For example, the risk determination may be an indication of which segment an entity falls into based on a first risk metric and a second risk metric associated with the entity (with the data set indicating the ranges of risk metrics associated with each segment). In another example, each segment may be associated with a specific risk score or decision. For example, a segment may correspond to an automatic loan approval up to a specific monetary amount. A risk determination for an entity that falls into the segment may include the automatic loan approval. Outputting the risk determination may include indicating the risk determination to a user (such as via a display), providing the risk determination to the interface 110 for transmission to a user device, or providing the risk determination to the interface 110 for transmission to another device (such as a credit firm using the system 100 to determine whether a loan is to be approved).

Below are specific examples and implementation details regarding segmenting a group of objects concurrently based on a plurality of metrics. In the examples, segmentation is of credit risk (also referred to as credit worthiness) of entities (such as small businesses) for lending. Credit risk segmentation is used for underwriting and pricing decisions in lending (such as to small businesses), with the different segments indicating different tiers of credit risk. In the examples below, a specific credit risk is a loan default risk. Two credit scores may be used to determine an entity's credit risk (e.g., a likelihood to default on a loan), which is based on to which credit risk tier the entity corresponds based on the entity's first and second credit scores.

The system 100 may obtain the plurality of metrics in any suitable manner. For example, the system 100 may use one or more machine learning models to generate one or more credit scores using the credit firm's historical portfolio performance data (including number of loans and number of defaults). Alternatively, the one or more machine learning models may be executed by another system of the credit firm, and the credit scores generated by the one or more machine learning models may be received by the system 100 from the other system. Additionally or alternatively, the system 100 may receive one or more publicly available credit scores from a third-party source (such as a FICO score) for each entity of the group of entities.

To segment the group of entities into one or more segments, the system 100 may generate a MIP model/problem that is to be solved to determine the final segments. To generate the MIP model, the system 100 generates a binning matrix for the group of objects (e.g., the group of entities) based on the set of first metrics (e.g., the set of first credit scores) and the set of second metrics (e.g., the set of second credit scores).

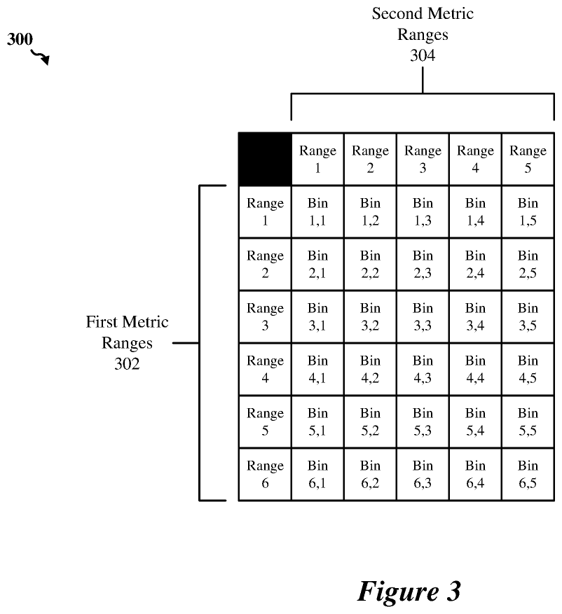

FIG. 3 shows an example binning matrix 300 for segmentation. The binning matrix 300 includes a vertical dimension associated with the first metric ranges 302 (which is illustrated as rows of the binning matrix 300. The binning matrix 300 also includes a horizontal dimension associated with the second metric ranges 304 (which is illustrated as columns of the binning matrix 300). The first metric is broken into six ranges in the binning matrix 300, and the second metric is broken into five ranges in the binning matrix 300. Each intersection of row x (for integer x from 1 to 6) and column y (for integer y from 1 to 5) of the binning matrix 300 corresponds to a bin x,y. For example, range 1 of the first metric and range 1 of the second metric corresponds to bin 1,1, range 3 of the first metric and range 2 of the second metric corresponds to bin 3,2, etc. For the binning matrix, the ranges along each dimension are in ascending or descending order.

To generate a binning matrix, the system 100 generates a first dimension of the binning matrix to include a plurality of ranges of the first metric. For example, the system 100 generates the vertical dimension of the binning matrix 300 to include the six first metric ranges. In a simplified example, if the first metric is an internally developed credit score, the overall range of the credit score may be from 1-120 (with a higher score indicating a lower credit risk), and the system 100 may generate the ranges of credit scores to be 120-101, 100-81, 80-61, 60-41, 40-21, and 20-1. While the example depicts the ranges as being uniform in size, any suitable ranges may be used, which may be uniform or non-uniform, subject to the ranges in the binning matrix being in ascending or descending order. For example, the boundaries of the ranges may be determined to cause a uniform distribution of entities across the rows of bins. The boundaries may also be based on one or more business requirements. For example, entities with a score below a threshold score may not be considered for a loan, and the segmentation may be based on entities with the credit score above the threshold score. In this manner, the binning matrix's ranges may be based on such business requirements (such as the lowest range's lower boundary equaling the threshold score).

The system 100 also generates a second dimension of the binning matrix to include a plurality of ranges of the second metric. For example, the system 100 generates the horizontal dimension of the binning matrix 300 to include the five second metric ranges. In a simplified example, if the second metric is a FICO score, the overall range of the FICO score may be from 600-850 (with a score below 600 not being considered for automatic approval of a loan or other determination to be made based on the segmentation), and the system 100 may generate the ranges of FICO scores to be 850-801, 800-751, 750-701, 700-651, and 650-600. While the example depicts the FICO ranges as being uniform in size, any suitable ranges may be used, which may be uniform or non-uniform, subject to the ranges in the binning matrix being in ascending or descending order.

Using the above example, range 1 of the first metric is 120-101, and range 1 of the second metric is 850-801. In this manner, an entity with a first credit score greater than 100 and a FICO score greater than 800 is associated with bin 1,1. An entity with a first credit score from 1-20 and a FICO score from 600-650 is associated with bin 6,5. In the binning matrix 300 for the above example, the first and second metrics decrease when traversing down and to the right of bin 1,1 towards bin 6,5. In another example, the first and second metrics may increase when traversing down and to the right of bin 1,1 towards bin 6,5. In other examples, the first and second metrics may increase or the first and second metrics may decrease when traversing up and to the right from bin 6,1 towards bin 1,5.

With the dimensions of metric ranges of the binning matrix generated (such as first metric ranges 302 and second metric ranges 304) to define the plurality of bins of the binning matrix, the system 100 populates, for one or more bins of the binning matrix, a bin with an integer entry associated with one or more objects in the group of objects to be represented by the bin. In some implementations, a bin may include or be associated with a plurality values. For example, the system 100 may populate a bin x,y with the number of objects (e.g., entities) in the group of objects that falls into the bin x,y based on the corresponding range of first metrics and the corresponding range of second metrics. In another example, the system 100 may populate the bin x,y with an integer metric of a characteristic of the one or more objects associated with the bin x,y. In a specific example regarding loan default risk, the bin x,y may be populated with one or more of a first integer indicating a number of loans provided to the entities that fall into the bin or a number of defaults associated with the number of loans. In some implementations, the system 100 may obtain the number of loans or the number of defaults from historical lending data of a credit firm using the system 100 or from publicly available data (such as from publicly available credit reports for companies). Segmenting the group of objects includes segmenting the binning matrix into a plurality of segments of bins. For example, neighboring bins may be grouped together into a segment. Segmentation may include determining segments of the binning matrix that maximizes a divergence in a characteristic of the objects (such as a loan default rate) among segments.

The example binning matrix 300 is depicted as a two-dimensional matrix based on a first metric and a second metric. In the example, each bin is depicted as a rectangle, with the bins arranged in a grid structure. However, a binning matrix may be a higher dimension matrix based on more than two metrics. For example, a binning matrix based on three metrics may be depicted as a three-dimensional matrix, and each bin may be a right rectangular prism. Four and higher dimensional matrices based on four or more metrics include orthotope (also referred to as hyperrectangle) shaped bins.

Segmenting the binning matrix causes the segmented binning matrix to include a monotonic trend in the characteristic across the plurality of segments along each dimension of the binning matrix. For example, referring back to binning matrix 300 based on two credit scores, a first segment may include bin 1,1, a second segment may include bin 3,1, and a third segment may include bin 5,1. The default rate determined for the segments trends up (or may remain the same) when traversing from bin 1,1 to bin 5,1. In a more general statement, the credit risk trends up when traversing from 1,y to bin 6,y for any integer y from 1 to 5 in the binning matrix 300. Similarly, the credit risk trends up when traversing from bin x,1 to bin x,5 for any integer x from 1 to 6 in the binning matrix 300. To extrapolate to both dimensions of the binning matrix 300, a credit risk associated with bin x,y is less than or equal to a credit risk associated with bin (x+1),y, bin x,(y+1), or bin (x+1),(y+1). As noted above, other example binning matrices associated with a credit risk (or other characteristic associated with the segmented binning matrix, such as an insurance liability risk) may have the credit risk (based on the segments) trend down when traversing one or more dimensions of the binning matrix as long as the trend remains monotonic along each dimension of the binning matrix.

Segmenting the binning matrix also causes the segmented binning matrix to include, for each segment including a plurality of bins, each bin of the plurality of bins neighboring at least one other bin of the plurality of bins. In other words, if a segment includes multiple bins, a bin cannot be spatially separated from all other bins in the segment. Conversely, a segment may not appear as a “doughnut” with one or more bins missing from the middle of the segment. For example, if a first segment of binning matrix 300 were to include bins r,s for integers r and s from 2-4 and exclude bin 3,3, bin 3,3 would be included in a different segment associated with a different credit risk than the first segment. As a result, the credit risk (based on the segments) would not be a monotonic trend along all dimensions of a segmented binning matrix.

In addition, segmenting the binning matrix causes the segmented binning matrix to include each bin of the segmented binning matrix in only one segment of the plurality of segments. In this manner, each entity may be associated with only one segment. In the above example, each entity is thus associated with only one credit risk (based on the associated segment).

The system 100 (such as segmentation module 140) to segment the binning matrix may be configured to determine a number of segments of the plurality of segments to maximize a divergence between segments. For example, the system 100 may determine the number of segments into which to segment the binning matrix 300 to maximize a divergence in credit risk between neighboring segments. The system 100 (such as segmentation module 140) to segment the binning matrix may also be configured to determine which bins of the binning matrix are to be included in each segment of the plurality of segments to maximize a divergence between segments. For example, the system 100 may assign each bin of the binning matrix 300 to a segment of the plurality of segments to maximize a divergence in credit risk (such as a loan default rate) among the segments. In the example of a system 100 determining a credit risk for loan approvals, a divergence in the credit risk may be indicated by an information value (IV) associated with a distribution of total defaults and a distribution of total non-defaults among segments (which is described in more detail in examples below). Maximizing the divergence in credit risk may include maximizing an information value (IV) determined for the segmented binning matrix. While the examples depict the system 100 using an IV as a divergence metric, any suitable divergence metric may be used for which the divergence metric may be determined for each segment. A suitable divergence metric may be determined for each segment without reliance on any portion of determining a divergence metric for a different segment. In other words, a suitable divergence metric may be determined for a segment independent of and without reference to any other segments. For example, the system 100 may determine a Jensen-Shannon Divergence (or other suitable divergence metric) based on the distribution of total defaults and the distribution of total non-defaults among segments.

The determination of the number of segments and the assignment of bins to segments is also to comply with a monotonic trend along each direction of the segment binning matrix, no segment including holes or bins not neighboring other bins in the same segment, and each bin being assigned to only one segment (as described above). To comply with the segmented matrix having a monotonic trend for the segments along each dimension and no segments including holes, the system 100 may segment the plurality of bins in the binning matrix into a group of orthotopes. To prevent a bin from being assigned to more than one segment, the orthotopes are non-overlapping. For example, to segment binning matrix 300, the bins of binning matrix 300 may be segmented into rectangular shaped segments of bins. The segmentation module 140 may include one or more constraints are equations embodied in software and/or hardware to ensure the system 100 generates segments that comply with the above rules.

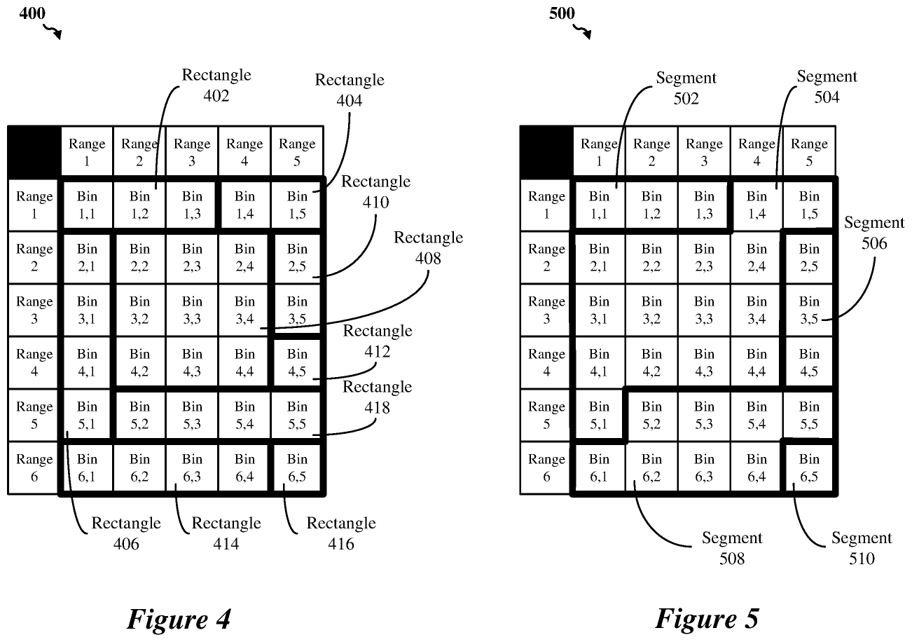

FIG. 4 shows an example rectangular shaped segmented binning matrix 400 based on the binning matrix 300 in FIG. 3. The rectangular shaped segmented binning matrix 400 includes rectangles 402-418. Rectangle 402 includes bin 1,1, bin,12, and bin 1,3. Rectangle 404 includes bin 1,4 and bin 1,5. Rectangle 406 includes bin 2,1, bin 3,1, bin 4,1, and bin 5,1. Rectangle 408 includes bin 2,2, bin 2,3, bin 2,4, bin 3,2, bin 3,3, bin 3,4, bin 4,2, bin 4,3, and bin 4,4. Rectangle 412 includes bin 4,5. Rectangle 414 includes bin 6,1, bin 6,2, bin 6,3, and bin 6,4. Rectangle 416 includes bin 6,5. Rectangle 418 includes bin 5,2, bin 5,3, bin 5,4, and bin 5,5. In some implementations, the rectangular shaped segmented binning matrix may be the final segmented binning matrix. In this manner, each rectangle 402-418 is associated with a different credit risk (with the credit risk trending down when traversing from bin 1,1 to bin 6,5 in the binning matrix 400). The system 100 may determine the rectangles 402-418 to optimize a divergence in a characteristic of the objects among segments (such as a credit risk/loan default rate). Such segmentation problem may be defined by an MIP model to ensure segmentation concurrently based on two or more metrics.

Below are examples depicting specific operations that may be performed by the system 100 to generate the MIP model and perform segmentation into orthotopes (referred to in the below examples as segments) in solving the MIP model. The examples are with reference to segmenting a group of entities (which are associated with loans provided to the entities) into segments to maximize a divergence in loan default rates among the segments of a segmented binning matrix. Maximizing the divergence in loan default rate may be based on maximizing an information value (IV) based on a distribution of total defaults and a distribution of total non-defaults for each segment. In addition, the below example operations are in light of possible business requirements, which may include limits on segment size and upper or lower bounds on the number of loans or number of loan defaults to exist per segment. The business requirements may also an upper or lower limit on the number of segments.

In some implementations, the equations, functions, variable definitions, constraints, and business requirements described below may be embodied in software of the segmentation module 140. For example, as noted above, one or more of the equations, functions, variable definitions, constraints, and business requirements described below may be embodied in a Python programming language format and based on the pywraplp API from the OR-Tools Suite. The memory 135 or the database 120 may store the software and the processor 130 may execute the software to perform one or more operations described herein regarding segmentation of a group of entities. Additionally or alternatively, one or more of the equations, functions, variable definitions, constraints, and business requirements described below may be embodied in hardware (such as one or more ASICs or other dedicated hardware) of the system 100 to perform one or more operations described herein.

The system 100 generates a binning matrix based on two credit scores (such as described above). The binning matrix is of size n rows x m columns. Indices i and j are used to indicate a row i and a column j of the binning matrix including n*m bins. In the below examples, [n₁,n₂] is used to denote the set of all integers from n₁ to n₂ (e.g., n₁, n₁+1, n₁+2, . . . , n₂). A segment (which is a rectangle in the example) is indicated as “beginning” at bin (i,j) (which may also be referred to as a cell, such as cell (i,j)). A segment is indicated as “ending” at bin (i′,j′) (also referred to as cell (i′,j′)). For clarity, cell (i,j) may be visualized as a top left corner of a segment, and cell (i′,j′) may be visualized as a bottom right corner of the segment. For example, referring back to FIG. 4, rectangle 408 “begins” at bin 2,2 and “ends” at bin 4,4.

For each cell (i,j) for all integer i from 1 to n and for all integer j from 1 to m, the system 100 determines the number of loans provided to the entities associated with the cell (denoted as Lᵢⱼ). For example, if 200 entities have a first credit score and a second credit score that fall within the ranges of credit scores associated with the cell, the system 100 determines the number of loans that have been provided to the 200 entities (such as loans from the credit firm itself based on historical data from the credit firm and/or an overall number of loans determined from publicly available credit reports of the entities). The system 100 may be configured to determine the number of loans based on a defined time period (such as loans provided by the credit firm in the last 2 years, 5 years, 10 years, etc.) to ensure freshness of the data. In some implementations, the database 120 may store the historical loan data from the credit firm or data determined from publicly available sources regarding the entities for the system 100 to determine the number of loans (as well as other variables described below).

The system 100 also determines the number of defaults for the number of loans for each cell (denoted as DO. For example, if the system 100 determines that 5,000 loans are provided to entities in a cell, the system 100 determines how many of the 5,000 loans went into default. While defaults are described, other measurements may be generated and used, such as number of delinquencies, number of late payments, etc. that may be determined form the historical loan data or from the publicly available data. Based on the number of loans and number of defaults per cell, the system 100 also determines a distribution of total defaults (also referred to as a default rate) and a distribution of total non-defaults (also referred to as a non-default rate) for each cell.

The system 100 determines the distribution of total defaults for each cell (i,j) (denoted a PDᵢⱼ) using equation (1) below:

$$P {D}_{ij} = \frac{{D}_{tj}}{{Σ}_{{i}^{′} = 1}^{n} {Σ}_{{j}^{′} = 1}^{m} {D}_{{i}^{′} {j}^{′}}} \qquad ( 1 )$$

As shown, the distribution of total defaults is based on the number of defaults D for the cell (i,j) and across the binning matrix. The distribution of total defaults for cell (i,j) is the number of defaults for cell (i,j) (Dᵢⱼ) divided by the total number of defaults across all cells of the binning matrix.

The system 100 determining the distribution of total non-defaults for each cell (i,j) (denoted as PGᵢⱼ) using equation (2) below:

$$P {G}_{ij} = \frac{{L}_{tj} - {D}_{tj}}{{\sum }_{{i}^{′} = 1}^{n} {\sum }_{{j}^{′} = 1}^{m} {L}_{{i}^{′} {j}^{′}} - {\sum }_{{i}^{′} = 1}^{n} {\sum }_{{j}^{′} = 1}^{m} {D}_{{i}^{′} {j}^{′}}} \qquad ( 2 )$$

As shown, the distribution of total non-defaults is based on the number of loans L and the number of defaults D for the cell (i,j) as well as across the binning matrix. The distribution of total non-defaults (the total non-default rate) for cell (i,j) is the number of loans that did not go into default for cell (i,j) (Lᵢⱼ−Dᵢⱼ) divided by the total number of loans that did not go into default across all cells of the binning matrix. In this manner, each cell of the binning matrix is associated with a number of loans, a number of defaults, a distribution of total defaults, and a distribution of total non-defaults.

To note, there are

$$\frac{m * ( m + 1 ) * n * ( n + 1 )}{4}$$

possible segments (rectangles) of an n×m binning matrix. To segment the binning matrix, the system 100 may determine the plurality of segments from the possible segments to maximize an IV across the segmented binning matrix. The IV may be based on the distribution of total defaults and the distribution of total non-defaults. The system 100 may determine an IV (denoted as V) for one or more possible segments of the binning matrix. The system 100 may determine a V_{iji′j′} for a segment beginning at cell (i,j) and ending at cell (i′,j′) using equation (3) below:

$${V}_{{iji}^{′} {j}^{′}} = {\sum }_{{i}^{o} = i}^{{i}^{′}} {\sum }_{{j}^{o} = j}^{{j}^{′}} \{ ( P {G}_{{i}^{o} {j}^{o}} - P {D}_{{i}^{o} {j}^{o}} ) \times ln ( \frac{{PG}_{{i}^{o} {j}^{o}}}{P {D}_{{i}^{o} {j}^{o}}} ) \} \qquad ( 3 )$$

If a different divergence metric than an IV is used (such as a Jensen-Shannon Divergence), equation (3) may be configured for the specific divergence metric. For a suitable divergence metric, the configured equation (3) may be solved independent of any other potential segment. In this manner, generating the divergence metric for a segment may be performed independently of all other potential segments of the binning matrix.

To note, business requirements on segmentation may also be specified as input parameters to generate an MIP model for segmentation. An example business parameter includes a lower bound on the number of segments (denoted as Rₗ), which ensure a sufficient number of segments or tiers to differentiate entities. Another example business parameter includes an upper bound on the number of segments (denoted as Rᵤ), which may balance depth of segmentation with the processing power required to perform segmentation as the number of segments increase. Another example business parameter includes a lower bound on the segment size (denoted as Qₗ), which may ensure a sufficient number of entities or loans are included in the same segment to prevent minor changes (such as one more or less number of defaults for the segment) having an outsized effect on the IV. Another example business parameter includes an upper bound on the segment size (denoted as Qᵤ), which may prevent too many entities or loans from being included in the same segment. Another example business parameter includes a minimum number of defaults per segment (denoted as B), which may ensure a sufficient amount of data per cell to determine an IV for each cell that differentiates from IVs determined for neighboring cells in the binning matrix.

As noted above, the system 100 may generate an MIP model to be solved for segmentation. Using the above example of a binning matrix, the MIP model may be based on the bottom right cell of a segment as a unique identifier of the segment. Each segment may also be defined using the top left cell of the segment. The system 100 may determine at least three sets of decision variables in generating the MIP model for the binning matrix.

A first decision variable indicates whether a cell (i,j) is assigned to a segment ending at cell (i′,j′) (denoted as x_{iji′j′}). For example, x_{iji′j′} may be a binary indicator that equals 1 if cell (i,j) is assigned to a segment ending at cell (i′,j′) and that equals 0 otherwise. The system 100 may determine x_{iji′j′} for all i, j, i′, and j′ (with i′ from 1 to n, j′ from 1 to m, i less than or equal to i′, and j less than or equal to j′).

To facilitate formulating the IV (and a default rate described in more detail below) for each segment, a second decision variable indicates an assignment of the upper left cell to a segment (denoted as y_{iji′j′}). For example, y_{iji′j′} may be a binary indicator that equals 1 if a segment begins at cell (i,j) and ends at cell (i′,j′) and that equals 0 otherwise. The system 100 may determine y_{iji′j′} for all i, j, i′, and j′ (with i′ from 1 to n, j′ from 1 to m, i less than or equal to i′, and j less than or equal to j′). The system 100 determining x_{iji′j′} and y_{iji′j′} for all i, j, i′, and j′ cause the system to determine all possible segments that may generated from the binning matrix.

A third decision variable indicates a default rate of a segment (denoted as w_{iji′j′}). For example, w_{iji′j′} may be a non-negative indicator that equals the total number of defaults for the segment over the total number of loans for the segment if x_{iji′j′}=1 and that equals 0 otherwise. The system 100 may determine w_{iji′j′} for all i, j, i′, and j′ (with i′ from 1 to n, j′ from 1 to m, i less than or equal to i′, and j less than or equal to j′). In this manner, the system 100 may determine a default rate for each of the possible segments that may be generated from the binning matrix.

For a constraint to restrict the number of segments in a segmented binning matrix, the system 100 may use an integer slack variable d (which is an integer from 0 to (Rᵤ−Rₗ)). For a constraint that restricts the segment size, the system 100 may use an integer slack variable u_{i′j′}, for the bottom right cell of segments (which is an integer from 0 to (Qᵤ−Qₗ) for all i′ from 1 to n and for all j′ from 1 to m).

The objective of the MIP model may be to maximize the IV by the system 100 segmenting the group of entities. In this manner, the system 100 may determine an optimum credit risk separation (such as a loan default rate separation) between the segments by solving the MIP model. As noted above, constraints on segmentation (which may also be referred to constraints on the MIP model) ensure that the shape of each segment is an orthotope (such as a rectangle for a two-dimensional binning matrix) and the default rates trend in a monotonic manner along each row and column of the binning matrix (or similar for higher order binning matrices).

The system 100 may determine a total IV for a segmented binning matrix as a sum of the IVs across all segments in the segmented binning matrix. The system 100 may determine the segmented matrix associated a maximum IV as compared to IVs for other potential segmented matrices. In particular, the system 100 may determine the plurality of segments (from the different combinations of possible segments for the different potential segmented binning matrices) that generates a maximum IV, as depicted in equation (4) below:

max(IV)=max(Σ_{i′=1}ⁿΣ_{j′=1}^{m}{Σᵢ₌₁^{i′}Σⱼ₌₁^{j′}V_{iji′j′}y_{iji′j′}}) (4)

As noted above, the system 100 assigns each cell to one and only one segment. In this manner, the system 100 using equation (4) to determine the plurality of segments is subject to equation (5) below:

Σ_{i′=1}ⁿΣ_{j′=j}^{m}x_{iji′j′},=1∀i∈[1,n],j∈[1,m] (5)

Also as noted above, the system 100 generates a segment that does not include any holes or outliers. For example, a segment may be an orthotope (such as a rectangle for a two-dimensional matrix). The system 100 being constrained to generating each segment without a hole in a rectangular shape of bins are defined in equations (6) and (7) below:

x_{iji′j′}−x_{(i+1)ji′j′}≤0∀i′∈[1,n],j′∈[1,m],i∈[1,i′],j∈[1,j′] (6)

x_{iji′j′}−x_{i(j+1)ji′j′}≤0∀i′∈[1,n],j′∈[1,m],i∈[1,i′],j∈[1,j′] (7)

Equation (6) indicates that if cell (i,j) is assigned to a segment ending at cell (i′,j′), the cell one row below cell (i,j) (which is cell (i+1,j)) is to be in the same segment for i less than i′. Equation (7) indicates that if cell (i,j) is assigned to a segment ending at cell (i′,j′), the cell one column to the right of cell (i,j) (which is cell (i,j+1)) is to be in the same segment for j less than j′.

The system 100 being constrained to generating each segment without a hole in a rectangular shape of bins is also defined in equation (8) below:

x_{iji′j′}≥x_{(i+1)ji′j′}+x_{i(j+1)i′j′}−1∀i′∈[1,n],j′∈[1,m],i∈[1,i′],j∈[1,j′] (8)

Equation (8) indicates that is both the cell to the right and the cell below cell (i,j) are assigned to a segment ending at cell (i′,j′), cell (i,j) is also assigned to the segment ending at cell (i′,j′). Equations (6) and (7) are used to ensure cells subsequent to the top left cell of a segment are included in a segment up to the bottom right cell ending the segment. However, equations (6) and (7) do not prevent the top left cell from being excluded from the segment. The system 100 may prevent the top left cell from being excluded from a rectangular segment based on equation (8) (thus preventing a dent in the rectangle at the top left corner of the segment). In this manner, a system 100 may segment a binning matrix based on equations (6) through (8) to ensure that each segment is a rectangle (or other orthotopes based on the number of dimensions of the binning matrix).

As noted above, the metrics may trend in an opposite direction than in the examples above for a binning matrix. For example, referring back to FIG. 3, range 6 of the first metric ranges 302 may be the top row (with range 1 the bottom row) and/or range 5 of the second metric ranges 304 may be the left column (with range 1 the right column) of the binning matrix 300. In this manner, one or more of the equations herein (such as equations (6) through (8)) may be flipped or reversed based on the trend of metrics for each dimension of the binning matrix to be segmented.

As noted above, the system 100 may be restricted as to the number of segments to generate in segmenting the binning matrix (such as based on slack variable d). The system 100 may use the right bottom cell of segments to identify the number of segments and restrict the number of segments between Rₗ and Rᵤ based on equation (9) below:

Σ_{i′=i}ⁿΣ_{j′=j}^{m}x_{i′j′i′j′}−Rₗ−d=0 (9)

In equation (9), slack variable d indicates a value between Rₗ and Rᵤ to allow equation (9) to hold true. Slack variable d being bound by Rₗ and Rᵤ in equation (9) prevents the system 100 from determining a number of segments as being less than Rₗ or being greater than Rᵤ.

Also as noted above, the system 100 may be restricted as to a segment size for each segment. For example, the system 100 may restrict the number of loans per segment to between Qₗ and Qᵤ based on equation (10) below:

Σᵢ₌₁^{i′}Σⱼ₌₁^{j′}Lᵢⱼx_{iji′j′}−Qₗ−u_{i′j′}=0∀i′∈[1,n],j′∈[1,m] (10)

In equation (10), slack variable u_{i′j′} indicates a value between Qₗ and Qᵤ to allow equation (10) to hold true for each segment. Slack variable u_{i′j′} being bound by Qₗ and Qᵤ in equation (10) prevents the system 100 from determining a segment as being associated with a fewer number of loans than Qₗ or being associated with a greater number of loans than Qᵤ.

Also as noted above, the system 100 may be restricted as to a minimum number of defaults to be associated with each segment. For example, the system 100 may generate the segments to ensure at least a minimum number of defaults B per segment based on equation (11) below:

Σᵢ₌₁^{i′}Σⱼ₌₁^{j′}Dᵢⱼx_{iji′j′}≥B∀i′∈[1,n],j′∈[1,m] (11)

To segment a binning matrix, the system 100 may determine a top left cell of each segment. The system 100 may determine the top left cell of each segment based on equations (12)-(16) below:

$$\begin{matrix}{y}_{{iji}^{′} {j}^{′}} \leq {x}_{{iji}^{′} {j}^{′}} - \frac{x ( i - 1 ) {ji}^{′} {j}^{′}}{2} - \frac{{x}_{i ( j - 1 ) {i}^{′} {j}^{′}}}{2} & \begin{matrix}∀ {i}^{′} ∈ [ 1 , n ] , {j}^{′} ∈ [ 1 , m ] , \\ i ∈ [ 2 , {i}^{′} ] , j ∈ [ 2 , {j}^{′} ]\end{matrix}\end{matrix} \qquad ( 12 )$$

$$\begin{matrix}{y}_{{iji}^{′} {j}^{′}} \geq {x}_{{iji}^{′} {j}^{′}} - {x}_{( i - 1 ) {ji}^{′} {j}^{′}} - {x}_{i ( j - 1 ) {i}^{′} {j}^{′}} & \begin{matrix}∀ {i}^{′} ∈ [ 1 , n ] , {j}^{′} ∈ [ 1 , m ] , \\ i ∈ [ 2 , {i}^{′} ] , j ∈ [ 2 , {j}^{′} ]\end{matrix}\end{matrix} \qquad ( 13 )$$

$$\begin{matrix}{y}_{11 {i}^{′} {j}^{′}} = {x}_{11 {i}^{′} {j}^{′}} & ∀ {i}^{′} ∈ [ 1 , n ] , {j}^{′} ∈ [ 1 , m ]\end{matrix} \qquad ( 14 )$$

$$\begin{matrix}{y}_{1 {ji}^{′} {j}^{′}} = {x}_{1 {ji}^{′} {j}^{′}} - {x}_{1 ( j - 1 ) {i}^{′} {j}^{′}} & ∀ {i}^{′} ∈ [ 1 , n ] , {j}^{′} ∈ [ 1 , m ] , j ∈ [ 2 , {j}^{′} ]\end{matrix} \qquad ( 15 )$$

$$\begin{matrix}{y}_{{i1i}^{′} {j}^{′}} = {x}_{{i1i}^{′} {j}^{′}} - {x}_{( i - 1 ) 1 {i}^{′} {j}^{′}} & ∀ {i}^{′} ∈ [ 1 , n ] , {j}^{′} ∈ [ 1 , m ] , i ∈ [ 2 , {i}^{′} ]\end{matrix} \qquad ( 16 )$$

In generalizing equations (12) and (13), equation (12) indicates an upper bound for the second decision variable y_{iji′j′} (which is a binary variable either equaling 0 or 1). Equation (13) indicates a lower bound for the second decision variable y_{iji′j′}.

Equation (12) indicates that cell (i,j) is not the top left cell of a segment ending at cell (i′,j′) when cell (i,j) is not assigned to the segment. Referring back to the first decision variable x_{iji′j′} definition, when x_{iji′j′} equals 0, cell (i,j) is not assigned to the segment ending at cell (i′,j′). When x_{iji′j′} equals 0, then x_{(i-1)ji′j′} and x_{i(j-1)i′j′} equal 0 (e.g., based on equations (6) and (7) above). In this manner, y_{iji′j′} equals 0 when x_{iji′j′}, equals 0 (y_{iji′j′}≤0−0/2−0/2).

Equation (12) (in conjunction with equation (13)) also indicates whether cell (i,j) is the top left cell of the segment when the cell (i,j) is assigned to the segment ending at cell (i′,j′) (x_{iji′j′} equals 1). If cell (i,j) is the top left cell of the segment, the cell to the left of and the cell above cell (i,j) are not included in the segment (x_{(i-1)ji′j′} and x_{i(j-1)i′j′} equal 0). In this manner, y_{iji′j′}≤1−0/2−0/2=1 based on equation (12), and y_{iji′j′}≥1−0−0=1 based on equation (13). In this manner, equations (12) and (13) would indicate that 1≤y_{iji′j′}≤1. In other words, equations (12) and (13) would indicate that y_{iji′j′} equals 1.

If cell (i,j) is not the top left cell of the segment, at least one of the cell to the left of or the cell above cell (i,j) is also in the segment (one or both of x_{(i-1)ji′j′} or x_{i(j-1)i′j′} equal 1). In this manner, equation (12) indicates that y_{iji′j′} is less than or equal to either ½ or 0, and equation (13) indicates that y_{iji′j′} is greater than or equal to either 0 or −1. Equations (12) and (13) together indicate that −1 or 0≤y_{iji′j′}≤0 or ½. Referring to the second decision variable y_{iji′j′} definition above, y_{iji′j′} equals either 0 or 1. y_{iji′j′}=0 satisfies equations (12) and (13) (while y_{iji′j′}=1 does not satisfy equation (12)).

To note, equations (12) and (13) may be used for cell (i,j) when i and j are greater than or equal to 0. In other words, the system 100 may not determine whether cells in the top row of the binning matrix or the left column of the binning matrix is the top left cell of a segment based on equations (12) and (13). Referring to binning matrix 300, the system 100 may not use equations (12) and (13) to identify a top left cell of a segment for bins in range 1 of either the first metric ranges 302 or the second metric ranges 304.

To note, cell (1,1) is a top left cell of a segment since cell (1,1) is the overall top left cell in the binning matrix. The system 100 may identify to which segment that cell (1,1) is the top left cell based on equation (14). Except for cell (1,1), the system 100 may identify cells in the top row of the binning matrix (i=1) that are the top left cell of a segment based on equation (15), and the system 100 may identify cells in the left column of the binning matrix (j=1) that are the top left cell of a segment based on equation (16).

The system 100 may determine the default rate for each segment based on equations (17)-(19) below:

w_{iji′j′}≤Σᵢ_{^{o}}₌₁^{i′}Σⱼ_{^{o}}₌₁^{j′}Dᵢ_{^{o}}ⱼ_{^{o}}_{i′j′}yᵢ_{^{o}}ⱼ_{^{o}}_{i′j′}∀i′∈[1,n],j′∈[1,m],i∈[1,i′],j∈[1,j′] (17)

w_{iji′j′}≥Σᵢ_{^{o}}₌₁^{i′}Σⱼ_{^{o}}₌₁^{j′}(Dᵢ_{^{o}}ⱼ_{^{o}}_{i′j′}yᵢ_{^{o}}ⱼ_{^{o}}_{i′j′}+x_{iji′j′}−1) (18)

∀i′∈[1,n],j′∈[1,m],i∈[1,i′],j∈[1,j′]w_{iji′j′}≤x_{iji′j′}∀i′∈[1,n],j′∈[1,m],i∈[1,i′],j∈[1,j′] (19)

To note, the business parameter of the minimum number of defaults (B) for the segment ending at cell (i′,j′) (denoted as B_{i′j′}) and beginning at cell (i^{o},j^{o}) may be defined as Σᵢ_{^{o}}₌₁^{i′}Σⱼ_{^{o}}₌₁^{j′}Dᵢ_{^{o}}ⱼ_{^{o}}_{i′j′}yᵢ_{^{o}}ⱼ_{^{o}}_{i′j′}.

Equation (17) indicates an upper bound on the default rate for a segment, and equation (18) indicates a lower bound on the default rate for the segment. Based on the definition of B_{i′j′} above, equation (17) indicates that B_{i′j′} is the upper bound of the default rate w_{iji′j′}. When x_{iji′j′} equals 1 (indicating cell (i,j) is in the segment ending at cell (i′,j′)), equation (18) indicates that B_{i′j′} is the lower bound on the default rate w_{iji′j′}. In this manner, when equals 1, w_{iji′j′} equals B_{i′j′}.

Conversely, when x_{iji′j′} equals 0 (indicating cell (i,j) is not in the segment ending at cell (i′,j′)), equation (18) indicates a non-positive lower bound. Referring back to the third decision variable w_{iji′j′} definition, w_{iji′j′} is a non-negative variable. Equation (18) indicates a lower bound that is inherently met by w_{iji′j′} being non-negative when equals 0. As noted above, equation (17) indicates an upper bound of B_{i′j′} on the default rate w_{iji′j′}. In this manner, equations (17) and (18) may be used to define the default rate w_{iji′j′} when w_{iji′j′} equals 0 as in the range [0, B_{i′j′}].

The system 100 is configured to determine the default rate w_{iji′j′} as 0 when x_{iji′j′} equals 0. Equation (19) may be used to indicate that w_{iji′j′} is to be 0 when x_{iji′j′} equals 0. To note, w_{iji′j′} is a non-negative variable. When x_{iji′j′} equals 0, equation (19) indicates an upper bound on the default rate to be w_{iji′j′}≤x_{iji′j′}=0. In this manner, 0≤w_{iji′j′}≤0.

For any potential solution in segmenting the binning matrix, the default rate is to have a monotonic trend along each dimension of the segmented binning matrix. The system 100 may ensure that a segmented binning matrix includes a monotonic increasing trend in the default rate along each row of the segmented binning matrix based on equation (20) below:

Σᵢ₌ᵢⁿΣ_{j′=j}^{m}w_{iji′j′}≤Σ_{i′=i}ⁿΣ_{j′=j+1}^{m}w_{i(j+1)i′j′}∀i∈[1,n],j∈[1,m−1] (20)

Equation (20) indicates that for any two neighboring cells in any row of the segmented binning matrix, the segment to which the left cell is assigned is associated with a default rate that is less than or equal to the default rate associated with the segment to which the right cell is assigned. To note, the segment to which the left cell is assigned may be the same segment or a different segment to which the right cell is assigned (with equation (20) complying with both scenarios).

The system 100 may ensure that a segmented binning matrix includes a monotonic increasing trend in the default rate along each column of the segmented binning matrix based on equation (21) below:

Σ_{i′=i}ⁿΣ_{j′=j}^{m}w_{iji′j′}≤Σ_{i′i+1}ⁿΣ_{j′=j}^{m}w(i+1)_{ji′j′}∀i∀[1,n−1],j∈[1,m] (21)

Equation (21) indicates that for any two neighboring cells in any column of the segmented binning matrix, the segment to which the top cell is assigned is associated with a default rate that is less than or equal to the default rate associated with the segment to which the bottom cell is assigned. To note, the segment to which the top cell is assigned may be the same segment or a different segment to which the bottom cell is assigned (with equation (21) complying with both scenarios).

Equations (20) and (21) are specific to a monotonic increase trend in the default rate when traversing from left to right in each row or from top to bottom in each column of the segmented binning matrix. In some other implementations, the binning matrix may be configured such that a monotonic decreasing trend in the default rate is to exist when traversing from left to right in each row or from top to bottom in each column of the segmented binning matrix. In this manner, one or both of equations (20) or (21) may be reversed to account for the difference in the binning matrix.

The system 100 may use the equations (1) through (21) and the decision variable definitions defined above to generate the MIP problem for determining an optimized segmentation of the binning matrix. As noted above, the equations (1) through (21) and the decision variable definitions may be embodied in software of the segmentation module 140, which may be stored in memory 135 or database 120 and executed by processor 130, may be embodied in hardware, such as one or more ASICs or other dedicated hardware, or may be embodied in a combination of hardware and software.

After generating the binning matrix, the system 100 may use equations (1) through (21) to generate the MIP problem to be used to segment the binning matrix and to generate the segmented binning matrix by solving the MIP problem. In some implementations, the system 100 may determine a plurality of possible segmented binning matrices that comply with equations (5) through (21), and the system 100 may determine the final segmented matrix based on equation (4). However, the MIP problem (corresponding to the binning matrix, equations (1) through (21), and the decision variable definitions) may be solved in any suitable manner. In some implementations, a CBC solver may be used by the system 100 to solve the MIP problem. The system 100 generating and solving the MIP problem as described above ensures that the group of objects (such as a group of businesses) are segmented into different segments concurrently based on two or more metrics (such as two or more credit scores). In this manner, one metric does not have undue influence over the segmentation as compared to another metric's influence on the segmentation (such as that occurs in a hierarchical tree structure based segmentation).

In some implementations, the system 100 may combine one or more orthotopes from the group of orthotopes from segmenting the binning matrix to generate a final segment in a final segmented binning matrix. For example, the system 100 may combine two or more rectangles of a rectangle shaped segmented binning matrix (such as two or more of rectangles 402-418 in matrix 400) to generate a segment of a final segmented binning matrix. The orthotopes (such as the rectangles) to be combined are to be neighboring to prevent holes or to prevent a non-monotonic trend among the final segments.

FIG. 5 shows an example segmented binning matrix 500 based on the rectangle shaped segmented binning matrix 400 in FIG. 4. Segment 502 is the same as rectangle 402. Segment 504, though, is a combination of rectangles 404, 406, and 408. Segment 506 is a combination of rectangles 410 and 412. Segment 508 is a combination of rectangles 414 and 418. Segment 510 is the same as rectangle 416. In combining rectangles, the system 100 is configured to prevent a bin from a different segment from appearing between two bins in a same segment (to prevent a non-monotonic trend and to prevent holes in a segment).

In some implementations, combining the orthotopes into a segment may be based on one or more decision parameters or business requirements. For example, a credit firm may be structured to rank entities into five tiers of credit risk based on the binning matrix 300. The segmented binning matrix 400 includes nine rectangles based on an earlier bound of nine segments), which is to be reduced to a new maximum of five segments. In some implementations, the system 100 determines all possible combinations of rectangles to comply with monotonic trends and no holes in a segment, and the system 100 compares the possible combinations to determine a combination with a maximum divergence in credit risk between segments. For example, the system 100 determines the combination having a maximum IV (which may be a sum of the IVs across the segments of the combination). In some implementations, combining orthotopes may be performed by the MIP problem solver.

Additionally or alternatively, combining the orthotopes may be based on a user input or feedback. For example, a user may indicate one or more rectangles to be associated with a specific segment. The associations may be used by the system 100 to generate the final segments of the segmented binning matrix.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, and “one or more of: a, b, or c” is intended to cover: a, b, c, a-b, a-c, b-c, and a-b-c.

In the description, numerous specific details are set forth such as examples of specific components, circuits, and processes to provide a thorough understanding of the present disclosure. The term “coupled” as used herein means connected directly to or connected through one or more intervening components or circuits. The terms “processing system” and “processing device” may be used interchangeably to refer to any system capable of electronically processing information. The terms “based on a” and “based at least in part on” may be used interchangeably to refer to a dependency to at least a. Also, in the description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions are presented in terms of procedures, logic blocks, processing, and other symbolic representations of operations on data bits within a computer memory.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations to be performed in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles and the novel features disclosed herein.

What is claimed is:

1. A computer-implemented method for segmenting a group of objects by a system, comprising:
obtaining a set of first metrics for the group of objects, wherein the set of first metrics includes, for each object in the group of objects, a first metric associated with the object;
obtaining a set of second metrics for the group of objects, wherein the set of second metrics includes, for each object in the group of objects, a second metric associated with the object;
segmenting the group of objects into one or more segments concurrently based on the set of first metrics and the set of second metrics; and
generating a data set including the one or more segments, wherein the data set is stored by the system.

2. The method of claim 1, further comprising:
generating a risk determination of an entity based on the data set, wherein:
the group of objects is a group of entities;
the set of first metrics is a set of first risk metrics of the group of entities; and
the set of second metrics is a set of second risk metrics of the group of entities; and
outputting the risk determination of the entity.

3. The method of claim 1, further comprising generating a binning matrix for the group of objects based on the set of first metrics and the set of second metrics, including:
generating a first dimension of the binning matrix to include a plurality of ranges of the first metric;
generating a second dimension of the binning matrix to include a plurality of ranges of the second metric, wherein, for each pair of a range of the first metric and a range of the second metric, one or more bins of the binning matrix are associated with the pair; and
populating, for one or more bins of the binning matrix, a bin with an integer entry associated with one or more objects in the group of objects to be represented by the bin,
wherein segmenting the group of objects includes segmenting the binning matrix into a plurality of segments of bins.

4. The method of claim 3, wherein the segmented binning matrix includes:
a monotonic trend for the plurality of segments along each dimension of the binning matrix;
for each segment of the plurality of segments including a plurality of bins, each bin of the plurality of bins neighboring at least one other bin of the plurality of bins; and
each bin of the segmented binning matrix is included in only one segment of the plurality of segments.

5. The method of claim 4, wherein segmenting the binning matrix includes determining a number of segments of the plurality of segments and which bins of the binning matrix are to be included in each segment of the plurality of segments based on maximizing a divergence among segments.

6. The method of claim 5, wherein segmenting the binning matrix further includes:
segmenting the plurality of bins in the binning matrix into a group of orthotopes; and
for each segment of the plurality of segments, combining one or more orthotopes from the group of orthotopes to generate the segment.

7. The method of claim 5, wherein:
the set of first metrics is a set of first credit scores;
the set of second metrics is a set of second credit scores;
the group of objects is a group of entities, wherein each entity in the group of entities has a first credit score from the set of first credit scores and has a second credit score from the set of second credit scores; and
populating a bin of the binning matrix associated with a first range of first credit scores and a second range of second credit scores includes indicating a number associated with one or more entities from the group of entities having the first credit score in the first range of first credit scores and having the second credit score in the second range of second credit scores.

8. The method of claim 5, wherein:
generating the binning matrix includes determining, for each bin of the binning matrix:
a number of loans for the entities associated with the bin;
a number of defaults for the number of loans; and
a distribution of total defaults based on the number of defaults; and
a distribution of total non-defaults based on the number of loans and the number of defaults.

9. The method of claim 8, wherein each segment of the plurality of segments in the segmented binning matrix is associated with a default rate, wherein a trend of default rates is monotonic along each dimension of the segmented binning matrix for the plurality of segments.

10. The method of claim 9, wherein the divergence among segments is a divergence in an information value (IV) across all bins of the segmented binning matrix based on the distribution of total defaults and the distribution of total non-defaults.

11. A system for segmenting a group of objects, comprising:
one or more processors; and
a memory storing instructions that, when executed by the one or more processors, causes the system to perform operations comprising:
obtaining a set of first metrics for the group of objects, wherein the set of first metrics includes, for each object in the group of objects, a first metric associated with the object;
obtaining a set of second metrics for the group of objects, wherein the set of second metrics includes, for each object in the group of objects, a second metric associated with the object;
segmenting the group of objects into one or more segments concurrently based on the set of first metrics and the set of second metrics; and
generating a data set including the one or more segments, wherein the data set is stored by the system.

12. The system of claim 11, wherein execution of the instructions causes the system to perform operations further comprising:
generating a risk determination of an entity based on the data set, wherein:
the group of objects is a group of entities;
the set of first metrics is a set of first risk metrics of the group of entities; and
the set of second metrics is a set of second risk metrics of the group of entities; and
outputting the risk determination of the entity.

13. The system of claim 11, wherein execution of the instructions causes the system to perform operations further comprising generating a binning matrix for the group of objects based on the set of first metrics and the set of second metrics, including:
generating a first dimension of the binning matrix to include a plurality of ranges of the first metric;
generating a second dimension of the binning matrix to include a plurality of ranges of the second metric, wherein, for each pair of a range of the first metric and a range of the second metric, one or more bins of the binning matrix are associated with the pair; and
populating, for one or more bins of the binning matrix, a bin with an integer entry associated with one or more objects in the group of objects to be represented by the bin,
wherein segmenting the group of objects includes segmenting the binning matrix into a plurality of segments of bins.

14. The system of claim 13, wherein the segmented binning matrix includes:
a monotonic trend for the plurality of segments along each dimension of the binning matrix;
for each segment of the plurality of segments including a plurality of bins, each bin of the plurality of bins neighboring at least one other bin of the plurality of bins; and
each bin of the segmented binning matrix is included in only one segment of the plurality of segments.

15. The system of claim 14, wherein execution of the instructions to segment the binning matrix causes the system to perform operations comprising determining a number of segments of the plurality of segments and which bins of the binning matrix are to be included in each segment of the plurality of segments based on maximizing a divergence among segments.

16. The system of claim 15, wherein execution of the instructions to segment the binning matrix causes the system to perform operations comprising:
segmenting the plurality of bins in the binning matrix into a group of orthotopes; and
for each segment of the plurality of segments, combining one or more orthotopes from the group of orthotopes to generate the segment.

17. The system of claim 15, wherein:
the set of first metrics is a set of first credit scores;
the set of second metrics is a set of second credit scores;
the group of objects is a group of entities, wherein each entity in the group of entities has a first credit score from the set of first credit scores and has a second credit score from the set of second credit scores; and
execution of the instructions to populate a bin of the binning matrix associated with a first range of first credit scores and a second range of second credit scores causes the system to perform operations comprising indicating a number associated with one or more entities from the group of entities having the first credit score in the first range of first credit scores and having the second credit score in the second range of second credit scores.

18. The system of claim 15, wherein execution of the instructions to generate the binning matrix causes the system to perform operations comprising determining, for each bin of the binning matrix:
a number of loans for the entities associated with the bin;
a number of defaults for the number of loans;
a distribution of total defaults based on the number of defaults; and
a distribution of total non-defaults based on the number of loans and the number of defaults.

19. The system of claim 18, wherein each segment of the plurality of segments in the segmented binning matrix is associated with a default rate, wherein a trend of default rates is monotonic along each dimension of the segmented binning matrix for the plurality of segments.

20. The system of claim 18, wherein the divergence among segments is a divergence in an information value (IV) across all bins of the segmented binning matrix based on the distribution of total defaults and the distribution of total non-defaults.
